(19) United States
(12) Patent Application Publication
(10) Pub. No.: US 2014/0056450 A1
(43) Pub. Date: Feb. 27, 2014

(54) APPARATUS AND METHOD FOR PSYCHOACOUSTIC BALANCING OF SOUND TO ACCOMMODATE FOR ASYMMETRICAL HEARING LOSS

(71) Applicant: Able Planet Inc., Wheat Ridge, CO (US)

(72) Inventor: Kevin Semcken, Evergreen, CO (US)

(73) Assignee: Able Planet Inc., Wheat Ridge, CO (US)

(21) Appl. No.: 13/970,435

(22) Filed: Aug. 19, 2013

Related U.S. Application Data
(60) Provisional application No. 61/692,108, filed on Aug. 22, 2012.

(51) Int. Cl. H04S 1/00

(52) U.S. Cl. CPC H04S 1/005
USPC 381/309

(57) ABSTRACT

An apparatus and method for psychoacoustic balancing of sound to accommodate for asymmetrical hearing loss which may be advantageously provided as a slim, hand holdable, in-line device for use in conjunction with electronic audio equipment comprising one or more of a balance control, a master volume control for easy adjustment of sound volume for safe listening levels in conjunction with a tone control to control and/or modify bass response to customize sound for user preference and intelligibility.

### CROSS REFERENCE TO RELATED PATENT APPLICATIONS

The present invention is related to and claims priority from U.S. Provisional Patent Application Ser. No. 61/692,108 for “Apparatus and Method for Psychoacoustic Balancing of Sound to Accommodate for Asymmetrical Hearing Loss” filed Aug. 22, 2012, the disclosure of which is herein specifically incorporated by this reference in its entirety.

### BACKGROUND OF THE INVENTION

The present invention relates, in general, to the field of devices and methods for accommodating for hearing loss in a user of electronic audio equipment.

More particularly, the present invention relates to an apparatus and method for psychoacoustic balancing of sound to accommodate for asymmetrical hearing loss.

Simply put, asymmetric hearing loss is evident when an individual's hearing is worse in one ear with respect to the other ear. Although hearing will generally decrease equally in both ears as one ages, it may become worse on one side as opposed to the other due to repeated exposure to loud noise on one side, e.g. due to rifle fire or any of a variety of medical and/or unknown causes, including those occurring at birth or from infections.

Notwithstanding, hearing loss due to age or other factors usually begins in the higher frequencies and the loss can differ in each ear as noted above. The apparatus and method of the present invention disclosed herein advantageously enables a user of electronic audio equipment to balance and vary the sound volume levels between each ear to accommodate for asymmetrical hearing loss and to customize the tone for preference and intelligibility.

### SUMMARY OF THE INVENTION

As disclosed herein, the apparatus and method of the present invention enables a user to psychoacoustically balance sound levels to accommodate for asymmetrical hearing loss. An apparatus in accordance with the technique of the present invention advantageously provides a slim, hand holdable, in-line device for use in conjunction with electronic audio equipment which comprises a master volume control for easy adjustment of sound volume for safe listening levels in conjunction with a tone control to control and/or modify bass response to customize sound for user preference and intelligibility.

Representative embodiments of the present invention in accordance with the disclosure herein may comprise devices that incorporate a balance control, a tone control and a volume control, with or without an amplifier. Other embodiments of the present invention may comprise a device incorporating various permutations of the foregoing features inclusive of those having a tone control alone; a tone control and an amplifier, with or without a volume control; a tone control and a volume control; a balance control and amplifier and/or a volume control and amplifier.

Particularly disclosed herein is a device which comprises an input adapted for receiving first and second electrical signals corresponding to left and right channel audio information. A balance control is adapted for determining a ratio of the amplitude between the first and second electrical signals and a volume control is adapted for determining the level of the first and second electrical signals. A tone control is adapted for determining the desired frequency components of the first and second electrical signals and an output is adapted for providing the first and second electrical signals from said balance, volume and tone controls to respective first and second audio transducers.

Also particularly disclosed herein is a method for enabling psychoacoustic balancing of sound for a user which comprises the steps of: providing an input adapted to receive first and second electrical signals corresponding to left and right channel audio information; providing a balance control adapted for determining a ratio of amplitude between the first and second electrical signals; providing a volume control adapted for determining a level of the first and second electrical signals; providing a tone control adapted for determining desired frequency components of the first and second electrical signals; and providing an output adapted for delivering the first and second electrical signals to respective first and second audio transducers.

### BRIEF DESCRIPTION OF THE DRAWINGS

The aforementioned and other features and objects of the present invention and the manner of attaining them will become more apparent and the invention itself will be best understood by reference to the following description of a preferred embodiment taken in conjunction with the accompanying drawings, wherein:

FIG. 1 is a perspective view of a representative embodiment of the present invention in the form of a slim, in-line package device for coupling between an electronic audio source and, for example, a set of earphones, ear buds, headphones, other audio signal transducers or the like and which incorporates a user adjustable master volume control, a balance control and a tone control;

FIG. 2 is a schematic illustration of the electrical circuitry of the representative embodiment of the device of FIG. 1 inclusive of line-in and line-out audio jacks;

FIGS. 3A and 3B are respective top side and back side views of the in-line package device of FIG. 1;

FIGS. 4A and 4B are respective left and right side views of the in-line package device of the preceding figures; and

FIGS. 5A and 5B are respective line-in and line-out end views of the in-line package device of the preceding figures.

### DESCRIPTION OF A REPRESENTATIVE EMBODIMENT

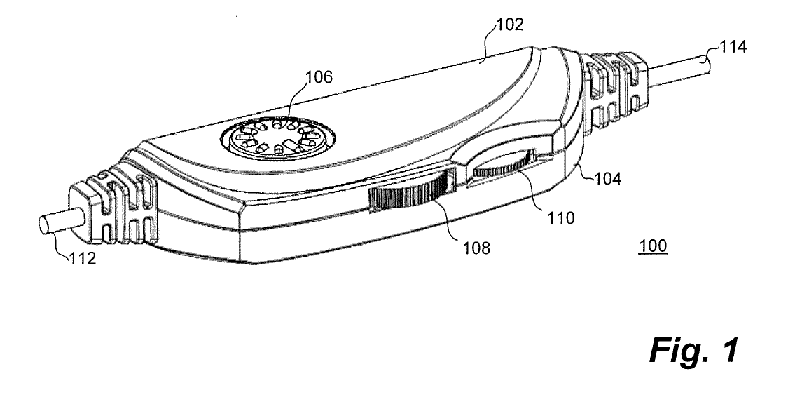

With reference now to FIG. 1, a perspective view of a representative embodiment of the present invention in the form of a slim, in-line package device 100 is shown. The device 100 enables coupling between an electronic audio source and, for example, a set of earphones, ear buds, headphones, other audio signal transducers or the like (not shown).

The device 100 comprises a case top 102 and corresponding case back 104 which serves as a housing for the electrical components of the device 100 which shall be described in greater detail hereinafter. External user manipulatable controls for the representative embodiment of the device 100 include a balance control wheel 106, a master volume control wheel 108 and a tone control wheel 110. It should be noted that although these controls are illustrated as comprising rotary control wheels, one or more of the balance control wheel 106, master volume control wheel 108 and tone control wheel 110 may also be provided as slide controls or other types of control devices. Audio signals to the device 100 are received on line-in 112 and output to the user on line-out 114. As illustrated, strain relief structures may be incorporated at the proximal ends of the line-in 112 and line-out 114.

It should be noted that, although not specifically illustrated, the device 100 may optionally include an additional and/or internal amplifier and associated power supply (e.g. a battery or other power source such as a USB port and the like) for amplifying the audio signals received on the line-in 112 and providing amplified audio output on line-out 114.

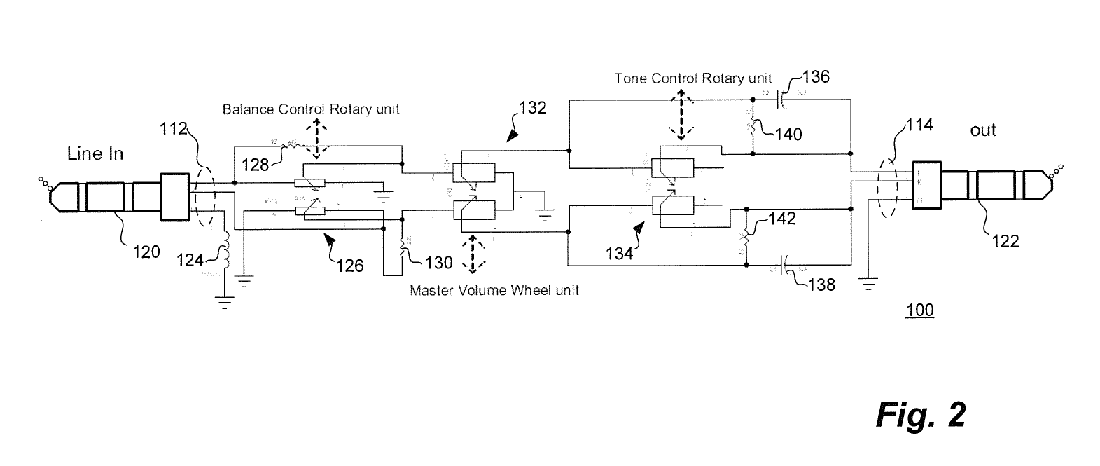

With reference additionally now to FIG. 2, a schematic illustration of the electrical circuitry of the representative embodiment of the device 100 of FIG. 1 is shown inclusive of line-in and line-out audio jacks 120, 122 respectively. The line-in audio jack 120 provides electrical audio signals on line-in 112 to a balance control rotary unit 126, the resistance of which is variable by a user through adjustment of the balance control wheel 106 (FIG. 1). An inductor 124 couples the ground (G) terminal of the line-in 112 to circuit ground while resistors 128 and 130 couple the respective left (L) and right (R) terminals to the master volume wheel unit 132. Resistors 128, 130 may conveniently comprise 220 ohm devices. The resistance of the master volume wheel unit 132 is adjustable by a user through manipulation of the master volume control wheel 108 (FIG. 1).

Electrical signals from the master volume wheel unit 132 are then received by the tone control rotary unit 134 which is also a variable resistance device operated by user adjustment of the tone control wheel 110 (FIG. 1). Resistive/capacitive networks comprising capacitor 136 with resistor 140 and capacitor 138 with resistor 142 couple the electrical signals from the master volume control wheel unit 132 and tone control rotary unit 134 to the line-out 114 and line out audio jack 122. Capacitors 136, 138 may conveniently comprise 1μF devices.

It should be noted that the device 100 may also function in conjunction with electrical signals incorporating haptic or vibratory signals as well for use in conjunction with a haptic output device. In this regard, the master volume control wheel 108 can function to determine a preferred amplitude of the haptic signal while the tone control wheel 110 can function to set a preferred filter function for the haptic signal. In this regard, the device 100 can then function to completely pass through a haptic signal to a haptic output device, prohibit it completely or alter it by attenuating it to a desired extent.

Stated another way, the device 100 may be implemented to function as a controller through which audio signals may be received from associated audio equipment. This audio signal may be transmitted unaltered or converted from the original signal to signals for transmission to a haptic output device thereby determining an output force and direction required to move the haptic output device from the current position to the preferred position. The device 100 may be used to modify the output force and direction of the haptic output device by creating a filter function to alter the frequency response and to define the frequency components for movement effected by the haptic output device.

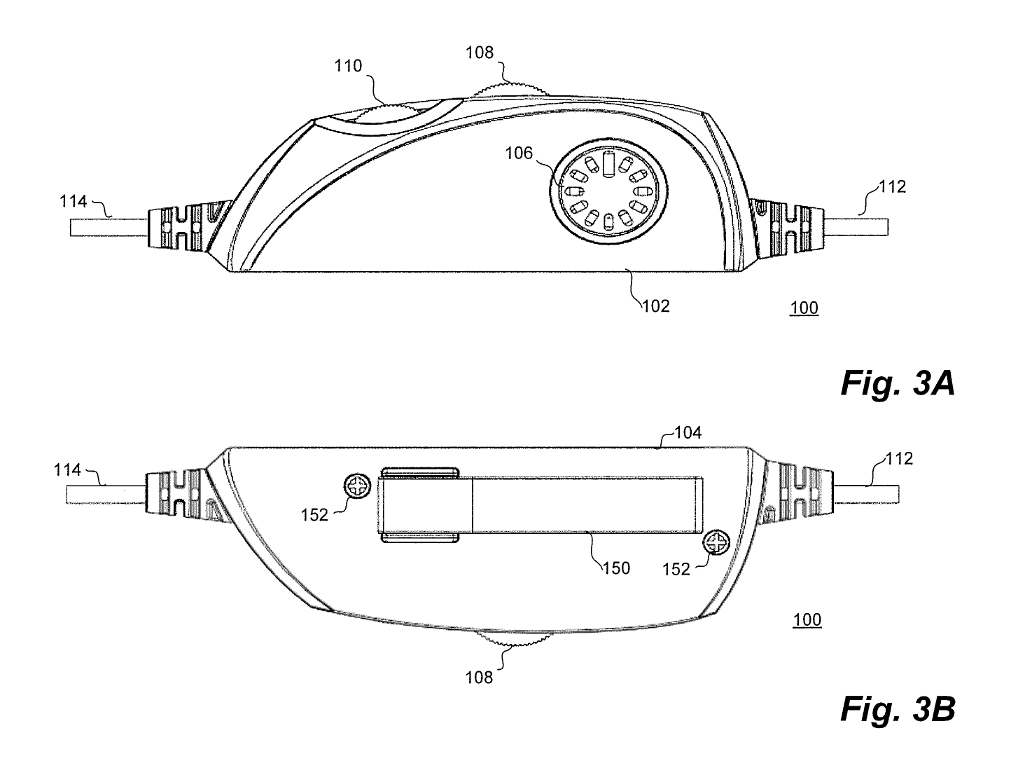

With reference additionally now to FIGS. 3A and 3B, respective top side and back side views of the in-line package device 100 of FIG. 1 are shown. With respect to the elements illustrated, like structure to that previously described with respect to the preceding figures is like numbered and the foregoing description shall suffice herefor. As illustrated, the device 100 may also conveniently incorporate a metal clip or clasp 150 to enable the device 100 to be conveniently clipped to a user's belt, pocket or the like. Also as illustrated, the case top 102 and corresponding case back 104 may be secured to each other by means of one or more screws 152 or other securing elements.

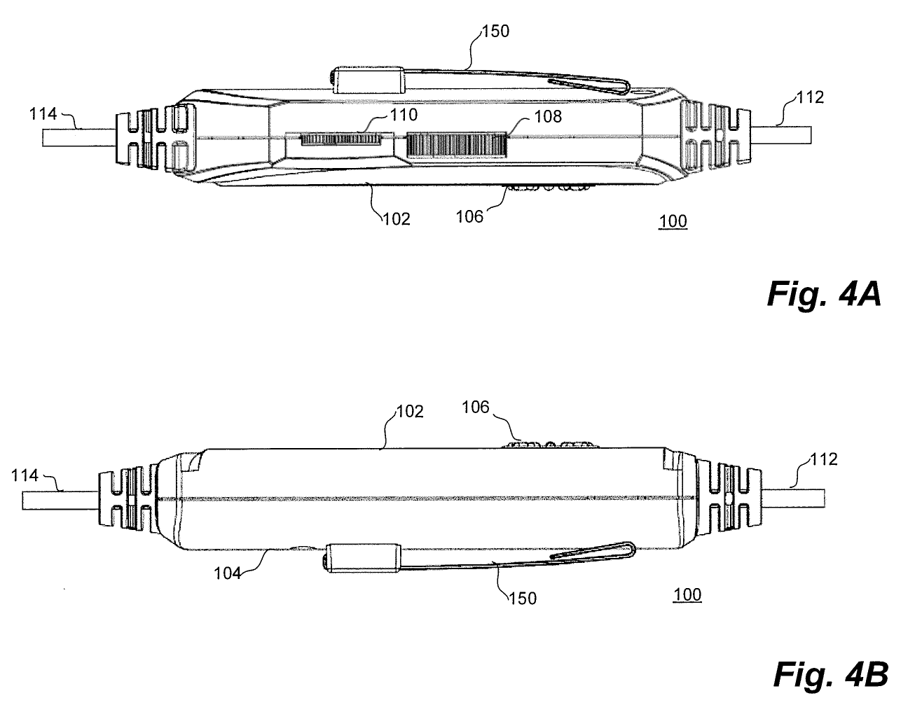

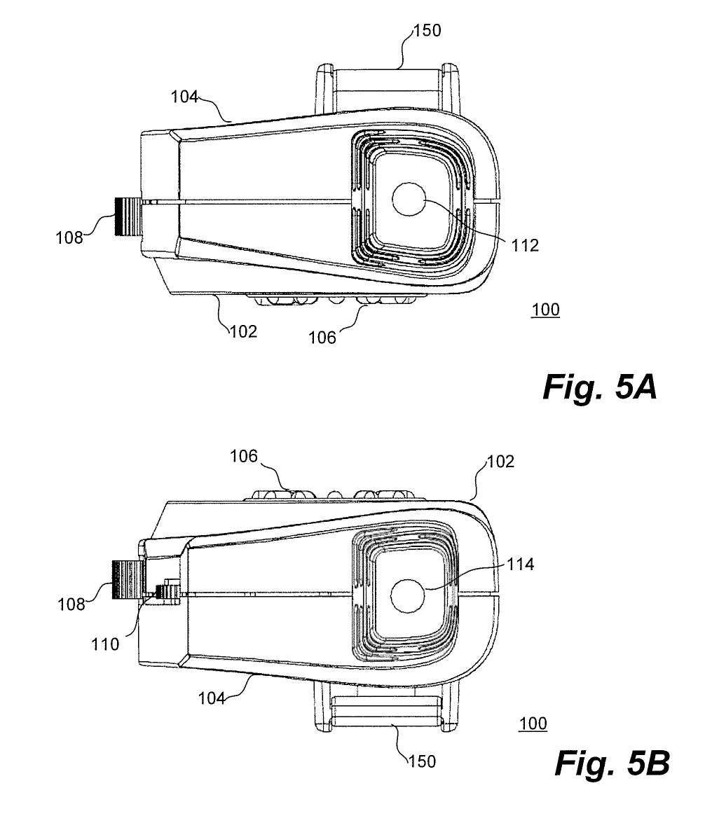

With reference additionally now to FIGS. 4A and 4B, respective left and right side views of the in-line package device 100 of the preceding figures are shown. With further reference to FIGS. 5A and 5B, respective line-in and line-out end views of the in-line package device 100 of the preceding figures are also illustrated. With respect to FIGS. 4A, 4B, 5A and 5B, like structure to that previously described with respect to the preceding figures is also like numbered and the foregoing description shall suffice herefor.

While there have been described above the principles of the present invention in conjunction with specific apparatus, it is to be clearly understood that the foregoing description is made only by way of example and not as a limitation to the scope of the invention. For example, a device in accordance with the present invention may naturally be utilized by any user of the device regardless of whether or not any type of hearing loss is involved. Further, although illustrated as having wired connections to receive electrical signals corresponding to left and right channel audio information and wired connections to respective first and second audio transducers, the electrical signals received by the device, and transmitted by the device to the audio transducers, may also be conveyed wirelessly.

Particularly, it is recognized that the teachings of the foregoing disclosure will suggest other modifications to those persons skilled in the relevant art. Such modifications may involve other features which are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The applicants hereby reserve the right to formulate new claims to such features and/or combinations of such features during the prosecution of the present application or of any further application derived therefrom.

As used herein, the terms “comprises”, “comprising”, or any other variation thereof, are intended to cover a non-exclusive inclusion, such that a process, method, article, or apparatus that comprises a recitation of certain elements does not necessarily include only those elements but may include other elements not expressly recited or inherent to such process, method, article or apparatus. None of the description in the present application should be read as implying that any particular element, step, or function is an essential element which must be included in the claim scope and THE SCOPE OF THE PATENTED SUBJECT MATTER IS DEFINED ONLY BY THE CLAIMS AS ALLOWED. Moreover, none of the appended claims are intended to invoke paragraph six of 35 U.S.C. Sect. 112 unless the exact phrase “means for” is employed and is followed by a participle.

What is claimed is:

1. A device comprising:
an input adapted for receiving first and second electrical signals corresponding to left and right channel audio information;
a balance control adapted for determining a ratio of amplitude between said first and second electrical signals;
a volume control adapted for determining a level of said first and second electrical signals;
a tone control adapted for determining desired frequency components of said first and second electrical signals; and
an output adapted for providing said first and second electrical signals from said balance, volume and tone controls to respective first and second audio transducers.

2. The device of claim 1 wherein said input comprises a first coaxial conductor.

3. The device of claim 2 further comprising an audio jack coupled to said first coaxial conductor for coupling said device to an electronic audio source.

4. The device of claim 1 wherein said balance control comprises a variable resistive element.

5. The device of claim 1 wherein said volume control comprises a variable resistive element.

6. The device of claim 1 wherein said tone control comprises a variable resistive element.

7. The device of claim 1 wherein said output comprises a second coaxial conductor.

8. The device of claim 7 further comprising an audio jack coupled to said second coaxial conductor for coupling said device to said first and second audio transducers.

9. The device of claim 1 wherein said balance control, said volume control and said tone control are contained in a housing displaced between said input and said output.

10. The device of claim 9 wherein said balance control is actuatable by a first rotary knob.

11. The device of claim 10 wherein said first rotary knob is positioned in a first recess within said housing.

12. The device of claim 9 wherein said volume control is actuatable by a second rotary knob.

13. The device of claim 12 wherein said second rotary knob extends at least partially distally from said housing.

14. The device of claim 9 wherein said tone control is actuatable by a third rotary knob.

15. The device of claim 14 wherein said third rotary knob extends at least partially distally from a second recess in said housing.

16. The device of claim 1 wherein said first and second audio transducers comprise one of earphones, ear buds or headphones.

17. The device of claim 1 further comprising an amplifier coupled between said input and said output.

18. The device of claim 9 wherein said housing comprises first and second case portions secured together surrounding said balance, volume and tone controls.

19. The device of claim 9 further comprising a clip attached to said housing.

20. The device of claim 9 wherein said housing is of a form factor enabling said housing to be held in the hand of a user.

21. A method for enabling psychoacoustic balancing of sound for a user comprising:
providing an input adapted to receive first and second electrical signals corresponding to left and right channel audio information;
providing a balance control adapted for determining a ratio of amplitude between said first and second electrical signals;
providing a volume control adapted for determining a level of said first and second electrical signals;
providing a tone control adapted for determining desired frequency components of said first and second electrical signals; and
providing an output adapted for delivering said first and second electrical signals to respective first and second audio transducers.

22. The method of claim 21 wherein said step of providing said input is carried out by a first coaxial conductor.

23. The method of claim 21 wherein said step of providing said balance control comprises providing a variable resistive element.

24. The method of claim 21 wherein said step of providing said volume control comprises providing a variable resistive element.

25. The method of claim 21 wherein said step of providing said tone control comprises providing a variable resistive element.

26. The method of claim 21 wherein said step of providing said output is carried out by a second coaxial conductor.

27. The method of claim 21 further comprising:
providing a housing for containing said balance control, said volume control and said tone control displaced between said input and said output.

28. The method of claim 21 further comprising the step of:
amplifying said first and second electrical signals between said input and said output.
